(19) United States
(12) Patent Application Publication
(10) Pub. No.: US 2026/0179225 A1
(43) Pub. Date: Jun. 25, 2026

(54) MEDICAL INFORMATION PROCESSING APPARATUS AND METHOD

(71) Applicant: CANON MEDICAL SYSTEMS CORPORATION, Tochigi (JP)

(72) Inventors: Francesco Dalla SERRA, Edinburgh (GB); Alison O'NEIL, Edinburgh (GB)

(73) Assignee: CANON MEDICAL SYSTEMS CORPORATION, Tochigi (JP)

(21) Appl. No.: 18/987,738

(22) Filed: Dec. 19, 2024

(51) Int. Cl. G06T 7/00; G06T 7/11; G06T 11/60; G06V 10/82; G06V 20/70

(52) U.S. Cl. CPC G06T 7/0016; G06T 7/11; G06T 11/60; G06V 10/82; G06V 20/70; G06T 2200/24; G06T 2207/20081; G06T 2207/20084; G06T 2207/20104; G06T 2207/30048; G06T 2207/30061; G06T 2207/30096; G06T 2210/41

(57) ABSTRACT

A medical information processing apparatus comprises processing circuitry configured to:
input medical image data generated by a medical imaging apparatus to a first generative model that is configured to generate one or more findings based on the medical image;
input the medical image data, question information, and the generated one or more findings to a second generative model that is configured to output answer information related to the medical image data; and
display, on a display device, the answer information and at least part of the medical image generated by the medical imaging apparatus.

### FIELD

Embodiments described herein relate generally to an apparatus and method for processing medical information, and in particular but not exclusively, to the automatic determination of medical information by text generative models.

### BACKGROUND

Visual Question Answering (VQA) involves answering questions comprising natural language about the contents of an image. In deep learning systems, Visual Question Answering (VQA) is generally performed by training an Answer Generator (AG) model to generate a text answer for a text question which is input alongside the target image. VQA involves answering text questions about the contents of an image e.g. “How many cars are in this image?” or “What is the colour of the man's coat?”. In the medical domain, the questions usually relate to medical images e.g. “How many nodules in the left lung?” or “Is the heart enlarged?”.

### BRIEF DESCRIPTION OF THE DRAWINGS

Embodiments are now described, by way of non-limiting example, and are illustrated in the following figures, in which:

FIG. 1 is a schematic diagram of a method for visual-question-answering;

FIG. 2 is a schematic of an apparatus for processing medical information according to an embodiment;

FIG. 3 is a schematic illustration of a method for processing medical information in accordance with an embodiment;

FIG. 4 is a schematic illustration of a method in accordance with an embodiment;

FIG. 5 is a schematic illustration of a method in accordance with a further embodiment; and

FIG. 6 is a schematic illustration of a method in accordance with another embodiment.

### DETAILED DESCRIPTION

Certain embodiments provide a medical information processing apparatus comprising processing circuitry configured to:
input medical image data generated by a medical imaging apparatus to a first generative model that is configured to generate one or more findings based on the medical image;
input the medical image data, question information, and the generated one or more findings to a second generative model that is configured to output answer information related to the medical image data; and
display, on a display device, the answer information and at least part of the medical image generated by the medical imaging apparatus.

Certain embodiments provide a medical imaging diagnostic apparatus comprising:
a scanner configured to scan a patient to obtain a medical image data set; and
processing circuitry configured to:
   input the medical image data to a first generative model that is configured to generate one or more findings based on the medical image;
   input the medical image data, question information, and the generated one or more findings to a second generative model that is configured to output answer information related to the medical image data; and
   display, on a display device, the answer information and at least part of the medical image generated by the medical imaging apparatus.

Certain embodiments provide a medical information processing method comprising:
inputting medical image data generated by a medical imaging apparatus to a first generative model that is configured to generate one or more findings based on the medical image;
inputting the medical image data, question information, and the generated one or more findings to a second generative model that is configured to output answer information related to the medical image data; and
displaying, on a display device, the answer information and at least part of the medical image generated by the medical imaging apparatus.

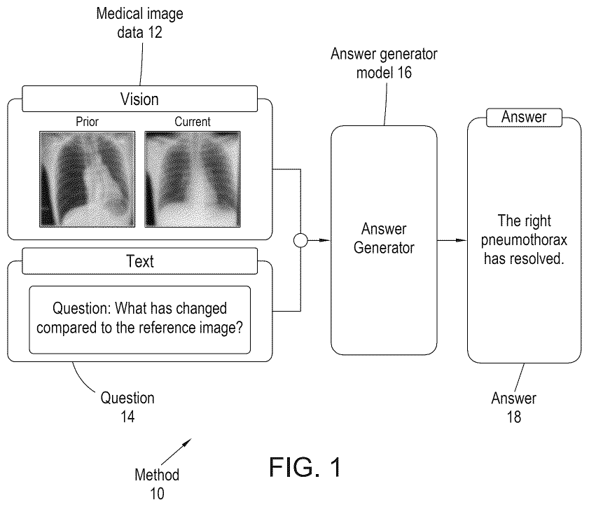

FIG. 1 shows an overview of a VQA deep learning process 10. In FIG. 1, medical image data 12 and a question 14 posed in natural language by a user is provided to an answer generator model 16. The answer generator model 16, which is a generative model, determines the answer 18. In FIG. 1, the medical image 12 comprises images of a patient's lung taken at different points in time while the question 14 asks whether anything has changed during the time interval between the obtaining of the lung images. The answer generator model 16 responds to the question 14 with answer 18, specifically, by reporting that “the right pneumothorax has resolved”.

It is possible to use a “chain of thought” prompting technique for VQA tasks which comprises:
a) The user manually writing “rationales”, comprising reasoning relevant to each question-answer pair;
b) Training a first generative model to generate “rationales” based on input image data and a question posed in natural language;
c) Training a second generative model to answer questions based on the input image data, the question and the rationale generated in (b).

It is also possible to use a computer aided design (CAD) algorithm to process image data before the use of a machine learning model, such as a large language model (LLM) to refine results. LLMs have difficulty processing images whereas CAD algorithms have seen significant success in the processing of images. A generative model may be trained to generate CAD outputs, such as classifications, lesion segmentations and reports. An LLM is then used to reorganise the generated outputs in text format using natural language.

Automated radiology reporting is a task that involves generating accurate radiology reports based on medical imaging data and is also possible.

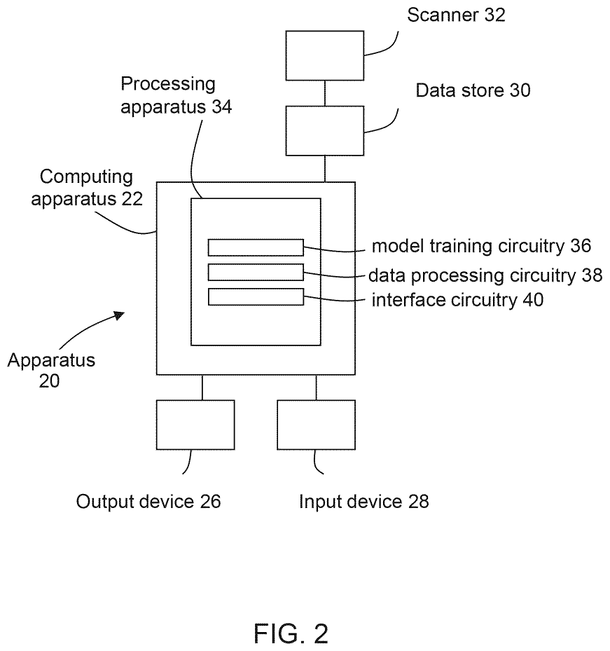

A data processing apparatus 20 according to an embodiment is illustrated schematically in FIG. 2. In the present embodiment, the data processing apparatus 20 is configured to process medical information including image data and semantic data. In other embodiments, the data processing apparatus 20 may be configured to process any other appropriate medical information.

The data processing apparatus 20 comprises a computing apparatus 22, which in this example is a personal computer (PC) or workstation. The computing apparatus 22 is connected to one or more output devices 26, such as a screen or other display device, and one or more input devices 28, such as a computer keyboard and mouse.

The computing apparatus 22 is configured to obtain data sets from a data store 30. At least some of the data obtained from the data store comprises medical information including medical imaging data, for instance, imaging data obtained using a scanner 32. The medical image data may comprise two-, three- or four-dimensional data in any medical imaging apparatus. For example, the scanner 32 may comprise a magnetic resonance (MR or MRI) scanner, CT (computed tomography) scanner, cone-beam CT scanner, X-ray scanner, ultrasound transducer, PET (positron emission tomography) scanner or SPECT (single photon emission computed tomography) scanner. Therefore, the scanner 32 is a medical imaging apparatus. Medical image data 52 is generated by a medical imaging apparatus.

The computing apparatus 22 may receive data from one or more further data stores (not shown) instead of or in addition to data store 30. For example, the computing apparatus 22 may receive medical image data from one or more remote data stores (not shown) which may form part of a Picture Archiving and Communication System (PACS) or other information system.

Computing apparatus 22 provides a processing resource for automatically or semi-automatically processing the data. Computing apparatus 22 comprises a processing apparatus 34. The processing apparatus 34 comprises model training circuitry 36 configured to train one or more models, such as machine learning models and generative models; data processing circuitry 38 configured to apply trained model(s) and to perform other processes for example image classification, visual question answering, image captioning and automated reporting; and interface circuitry 40 configured to obtain user or other inputs and to output results of the data processing.

In the present embodiment, the circuitries 36, 38 and 40 are each implemented in computing apparatus 22 by means of a computer program having computer-readable instructions that are executable to perform the method of the embodiment. However, in other embodiments, the various circuitries may be implemented as one or more ASICs (application specific integrated circuits) or FPGAs (field programmable gate arrays).

The computing apparatus 22 also includes a hard drive and other components of a PC including RAM, ROM, a data bus, an operating system including various device drivers, and hardware devices including a graphics card. Such components are not shown in FIG. 2 for clarity.

The data processing apparatus 20 of FIG. 2 is configured to perform methods as illustrated and/or described in the following.

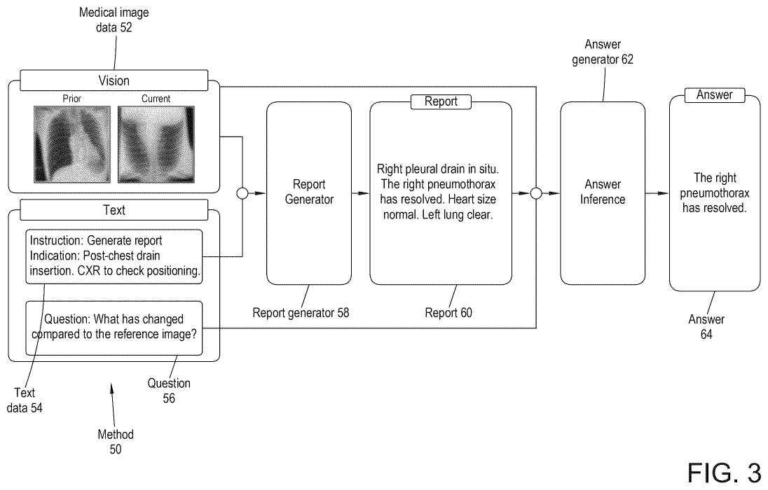

FIG. 3 illustrates a method 50 for processing medical information including medical images. In FIG. 3, medical image data 52 and text data 54 are provided to a report generator 58. The report generator 58 is a generative model and is also referred to as the first generative model. The medical image data 52 comprises images of the chest obtained using X-ray imaging. In other embodiments, any other form of medical images may be used. The image data comprises two images, one obtained before and the other obtained after a medical procedure. The text data 54 comprises instructions from a user for the report generator 58 (e.g. first generative model) to generate a report and indications, the indications specifically comprising “Post-chest drain insertion. CXR to check positioning” also provided to the report generator 58. The report generator 58 generates findings in the form of report 60 on the basis of the medical image data 52 and the text data 54. The report 60 comprises findings/evidence and recites: “Right pleural drain in situ. The right pneumothorax has resolved. Heart size normal. Left lung clear.” The image data and text data may be input as vector representations.

The medical image data 52, the report 60 comprising evidence/findings generated by the report generator 58 and a question 56 are then provided to an answer generator 62. The question 56 is in text format and may be composed in natural language. In FIG. 3, the question 56 recites: “What has changed compared to the reference image”. The answer generator 62 is a generative model and is also referred to as the second generative model. The answer generator 62 generates an answer 64 on the basis of the medical image data 52, the report 60 and the question 56. The question, report or other findings, and image data may be input as vector representations.

The answer 64 may be displayed to the user using the output device 26 (display device) of FIG. 2. The output device 26 may also display the medical image data 52 or a part thereof. The output device 26 may display the answer 64 and the medical image data 52 or parts thereof simultaneously. The output device 26 and/or the processing apparatus 34 may select part of the medical image data 52, the selection being based on the answer 64, and display the selected part of the medical image data 52. The output device 26 and/or processing apparatus 34 may select one or more display parameters, such as rendering parameters, and display at least part of the medical image data 52 in accordance with the one or more selected display parameters.

As described, the method 50 of FIG. 3 includes an intermediate step in which the report 60 is generated by a generative model before an answer generator model generates an answer to a question. This may be considered an intermediate ‘evidence generation’ step and the answer 64 may be considered grounded using the predicted radiology report.

In some embodiments medical image data 52 provided to the report generator may comprise a single image or a plurality of images which may or may not have a temporal relationship with each other. Any number of images obtained by any number of means may be included in the medical image data 52. Similarly, the text data 54 may comprise indications that are relevant to the medical image data and are not limited to the example of FIG. 3. In some embodiments only the medical image data 52 is provided to the report generator 58 and no text data 54 is provided. The text data 54 is not required in some embodiments and the report generator 58 may generate a report 60 without receiving text data 54. In some embodiments, the training of the report generator may dispense with the need for text data 54.

In some embodiments, the medical image data 52 may be multimodal and comprise, in addition to image data, semantic data or any other additional information. In such examples, the multimodal data may be provided to the report generator 58 in order to obtain a report 60.

The report generator 58 and the answer generator 62 may each comprise a machine learning model and/or a generative model such as an artificial neural network or a large language model (LLM) or a Generative Pre-trained Transformer (GPT) network or any combination of these. Any other text generation model may also be used. The report generator 58 may generate text in an auto-regressive manner. A Transformer network and/or a Long Short-Term Memory (LSTM) network may be used. In the embodiment of FIG. 3, the report generator 58 and the answer generator 62 have the same architecture but different weights due to being trained separately. In some embodiments, the report generator 58 and answer generator 62 may have different architectures. In some embodiments, the report generator 58 (or first generative model) may comprise a radiology report generator. The radiology report generator may be trained on the MIMIC-CXR dataset or a similar dataset. The MIMIC-CXR is a large publicly available dataset of chest radiographs with free-text radiology reports.

The table below lists different types of findings or evidence that may comprise the report 60:

| Finding/Evidence | Data Type |
|---|---|
| Findings and Impressions | Text |
| Coordinates of significant landmarks e.g. carina, tip | Point |
| of any visible tube (reports often contain sentences | coordinates |
| like “Endotracheal tube tip terminates approximately | |
| 4.5 cm from the carina.”) | |
| Segmentations of anatomical structures, derived | Segmentation |
| measurements (e.g. vessel diameters) | masks |
| Segmentations of pathologies, derived measurements | Segmentation |
| (e.g. volume of haemorrhage, length/width of tumour), | masks |
| radiomics features (texture, shape, etc.) | |
| Enhanced/derived images e.g. apply vesselness filter, | Images |
| create maximum/minimum/average intensity projection | |
| (MIP), apply bandpass filter to hone in on useful | |
| tissue intensity ranges | |

In addition to the table above, the findings/evidence that are included in the report may comprise a radiology report. The findings/evidence may comprise one or more of semantic data, image data and one or more segmentation masks.

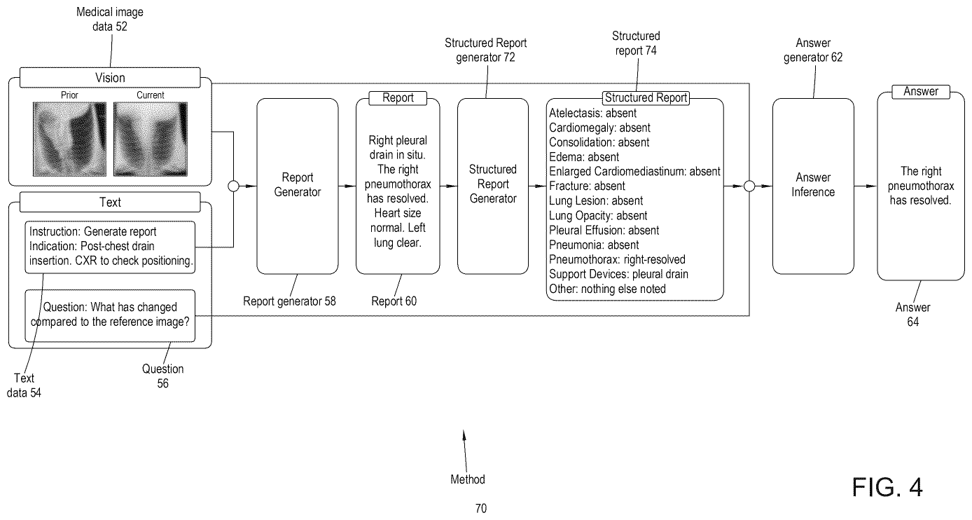

FIG. 4 illustrates a method 70 for processing medical images. Features already described in relation to FIG. 3 are not described in detail in relation to FIG. 3.

FIG. 4 shows a structured report generator 72 and a structured report 74 in addition to the elements previously described in relation to the embodiment of FIG. 3. The structured report generator 72 receives the report 60 comprising evidence/findings from the report generator 58 or first generative model as input. The structured report generator 72 is a generative model which organizes the report 60 into a more structured form in the structured report 74. In the example of FIG. 4, the structured report 74 comprises a list of medical conditions, their presence or absence and/or their status. The structured report 74 further comprises any medical devices identified in the medical image data 52.

The structured report 74 in the example of FIG. 4 recites:
“Atelectasis: absent
Cardiomegaly: absent
Consolidation: absent
Edema: absent
Enlarged Cardiomediastinum: absent
Fracture: absent
Lung lesion: absent
Lung opacity: absent
Pleural effusion: absent
Pneumonia: absent
Pneumothorax: right-resolved
Support devices: pleural drain
Other: nothing else noted”.

The structured report 74 is then provided to the answer generator 62 or second generative model in addition to the medical image data 52 and the question 56. The answer generator 62 generates the answer 64 on the basis of its inputs.

Method 70 adds the feature of ‘evidence sanitation’ or the structuring of reports to method 50. The report 60 generated by the report generator 58 will vary in the way that its contents are expressed and ordered from one instance of a report to another. Method 70 provides a consistent format for the report/findings/evidence provided to the answer generator 62 or second generative model. The structured report 74 contains only the information known to be reliably generated by the report generator 58. The processing circuitry may be use to assess reliability by evaluating metrics such as ‘Clinical Efficiency’ which assess the recall/precision with which each label, such as “pleural effusion”, “cardiomegaly”, and “support devices”, is detected in the generated text reports. An inspection may then be carried out by a user to select reliable information. Clinical Efficiency is one example and is mentioned for illustrative purposes. Any other suitable metric may be used.

‘Clinical Efficiency’ is described in “Jeremy Irvin et al, 2019. CheXpert: a large chest radiograph dataset with uncertainty labels and expert comparison. In Proceedings of the Thirty-Third AAAI Conference on Artificial Intelligence and Thirty-First Innovative Applications of Artificial Intelligence Conference and Ninth AAAI Symposium on Educational Advances in Artificial Intelligence (AAAl′19/lAAl′19/EAAl′19). AAAI Press, Article 73, 590-597. https://doi.org/10.1609/aaai.v33i01.3301590”.

The structured report generator 72 is configured to include or exclude data received at its input on the basis of the expected accuracy of the information and/or the type of information.

The structured report generator 72 may comprise one or more of a generative model, a machine learning model, a deep learning model, an LLM and a transformer. Any other text generation model may also be used. The structured report generator 72 may generate text in an auto-regressive manner. A Transformer network and/or a Long Short-Term Memory (LSTM) network may be used. In other embodiments, the structured report may follow a format different from the format shown in FIG. 4. The format in which the structured report 74 is composed may depend on the training of the structured report generator. In other embodiments, the structured report may comprise a list and/or status of anatomical features, pathological features or any other clinically relevant medical information.

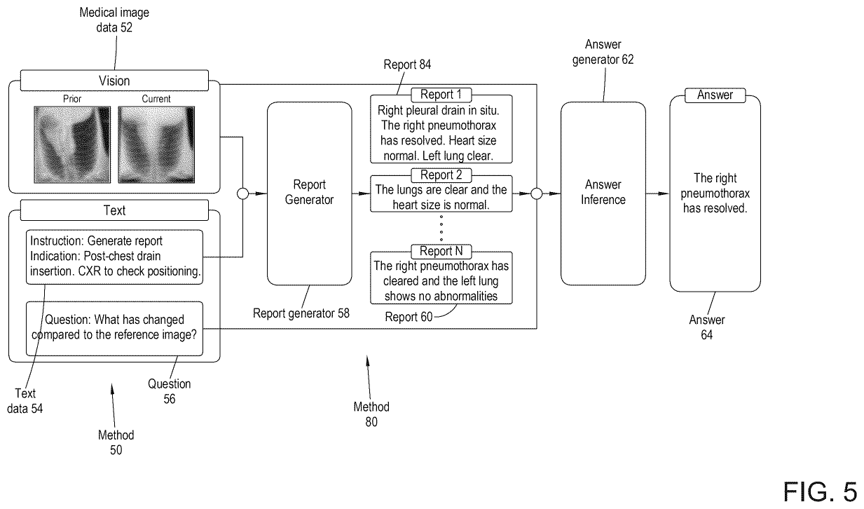

FIG. 5 illustrates a method 80 for processing medical images. Features already described in relation to FIG. 3 or 4 are not described in detail in relation to FIG. 5.

FIG. 5 shows a report generator 58 that generates three reports 82, 84 and 60 in contrast with the embodiment of FIG. 3 wherein only one report 60 is generated. In other embodiments, more or fewer reports may be generated by the report generator 58. Report 60 is identical to report 60 of FIG. 3, while report 84 and 82 are different.

Report 82 recites “The lungs are clear and the heart size is normal” while report 84 recites “The right pneumothorax has cleared and the left lung shows no abnormalities”.

The reports generated in method 80 may have different levels of completeness and may vary in contents as seen by the contrast between reports 60, 82 and 84.

Each of the generated reports 60, 82 and 84 are then provided to the answer generator 62 in addition to the medical image data 52 and the question 56. The answer generator 62 generates the answer 64 on the basis of its inputs.

Method 80 adds the feature of ensemble evidence to method 50. The multiple reports 82, 84, 60 generated by the report generator 58 may be generated by varying the medical image data 52 provided to the report generator 58 and/or the text data 54 provided to the report generator 58. Variations in image data 52 may comprise using rendering techniques to modify the medical image data 52 for each resulting report. The rendering techniques may include one or more of intensity transformations, spatial transformations and other rendering parameters. The variations in image data 52 may comprise selecting one or more subsets of the medical image data 52. The variation may be achieved by masking all or part of the clinical indications in the text data 54. The variation may be achieved by providing varied text data 54 to the report generator 58, such as different instructions and/or different indications. The variations may be the result of using multiple, differently trained report generators (not shown in FIG. 5).

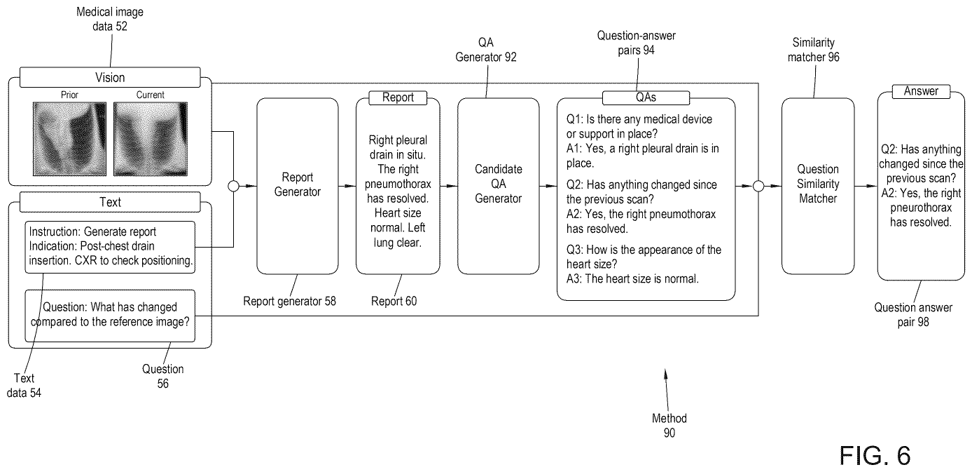

FIG. 6 illustrates a method 90 for processing medical images. Features already described in relation to FIG. 3, 4 or 5 are not described in detail in relation to FIG. 6.

Method 60 comprises a QA generator 92 which generates a set of question-answer pairs 94. The QA generator 92 is a generative model and uses the report 60 as an input. The questions-answer pairs 94 generated by the generator 92 on the basis of report 60 recite:
“Q1: Is there any medical device or support in place?
A1: Yes, a right pleural drain is in place.
Q2: Has anything changed since the previous scan?
A2: Yes, the right pneumothorax has resolved.
Q3: How is the appearance of the heart size?
A1: The heart size is normal.”

The question-answer pairs 94 may be generated using any suitable deep learning techniques or natural language processing (NLP) techniques. In other embodiments, the generator 92 may generate more or less than three question-answer pairs 94. The number of question-answer pairs 94 generated may depend on the training of the generator 92 and/or an input from the user. The question-answer pairs 94 are provided to a question similarity matcher 96 which is a generative model. The similarity matcher 96 further receives the question 56 as an input and selects one of a plurality of generated question-answers pairs as its output. The similarity matcher 96 selects the question answer pair 98 from the question-answer pairs 94 which is closest to the question 56 composed by the user. The similarity matches 96 may select a question-answer pair 98 on the basis of semantic similarity with the question 56, or on the basis of any other measure of similarity.

The direct matching of the user's question 56 to generated questions may be computationally simpler than directly answering a question. The QA generator 92 generates question-answer pairs 94 in anticipation of rather than with the knowledge of the user question 56. This means that the question 56 may be answered efficiently without the use of the answer generator 62 model of method 50.

The QA generator 92 and the similarity matcher 96 may comprise one or more of a machine learning model, a neural network, a deep learning model and a transformer. The QA generator 92 may generate text in an auto-regressive manner. The QA generator 92 may comprise any text generation model. A Transformer network and/or a Long Short-Term Memory (LSTM) network may be used. The similarity matcher may comprise a text classification model such as Bidirectional Encoder Representations from Transformers (BERT) or a text dual encoder model which uses cosine similarity or similar techniques to assess similarity.

In some embodiments, the scanner 32 may be configured to scan a patient to obtain a medical image data set, and the processing circuitry 38 inputs the medical image data to the first generative model 58 to generate one or more findings based on the medical image, and then inputs the medical image data, question information, and the generated one or more findings to the second generative model 62 to output answer information related to the medical image data.

The processing circuitry may configured to obtain at least one stored previously-obtained medical image data set and input the previously-obtained medical image data set to the first generative model 58 and/or to the second generative model 62 for comparison between the medical image data set and the previously-obtained medical image data set.

### Experimental Results

Method 50 was evaluated using the publicly available Medical-Diff-VQA dataset of chest X-Ray images and associated question/answer pairs. The Medical-Diff-VQA dataset comprises 700,000 question-answer pairs and about 220,000 images. 10% of the question-answer pairs and corresponding images were used for testing, 10% were used for validation and the remaining 80% were used for training the answer generator.

For the calculation of performance metrics, the questions were divided into questions with ‘short answers’ and ‘long answers’. For questions with short answers, such as yes/no questions, the accuracy of prediction was calculated versus the known ground truth. The accuracy shown in the table below is based on an exact match between the predicted answer and the ground truth answer. For question with long answers that exhibit higher variability, we report natural language generation metrics including BLEU, ROGUE, METEOR and CIDEr which measure the similarity between the predicted answers and the ground truth answers. The table below reports the performance metrics of the method 50 for three cases:
a) No report is generated by the Report generator 58 and the answer generator 62 receives medical image data 52 and question 56 as input.
b) The report generator is provided medical image data 52 and text data 54 and generates a report 60 comprising findings/evidence in text form before providing them to the answer generator 62. The answer generator 62 further receives the medical image data 52 and the question 56 as input.
c) The answer generator 62 is provided the medical image data 52, the question 56 and a ‘Ground Truth’ comprising text from an expert-written radiology report as input.

| | Short | Long answers | | | | |
|---|---|---|---|---|---|---|
| | answers | BLEU- | BLEU- | ME- | ROUGE- | |
| Evidence | Accuracy | 1 | 4 | TEOR | L | CIDer |
| None | 0.683 | 0.678 | 0.525 | 0.372 | 0.659 | 2.102 |
| Generated | 0.693 | 0.711 | 0.551 | 0.385 | 0.668 | 2.198 |
| Report | | | | | | |
| Ground | 0.751 | 0.723 | 0.570 | 0.398 | 0.685 | 2.484 |
| Truth | | | | | | |
| Report | | | | | | |

It can be seen from the table above that providing a generated report to the Answer Generation model boosts performance across all metrics. When we provide the ground truth report to the answer generator 62 we do not obtain perfect accuracy. Inspection of results revealed that the ‘ground truth’ radiology reports does not always contain complete information to answer the question-answer pairs, and that the answer generation model does not always perfectly interpret its text report input.

Some specific examples of applying method 50 with and without evidence/findings is presented in the following table. The first column of the table titled ‘Question’ refers to the question 56 asked by the user. The second column titled ‘Ground truth answer’ refers to text from the expert-written radiology report associated with the medical image data 52 provided. The third column titled ‘Predicted answer without evidence’ refers to the result of the method described in relation to FIG. 1 which is known. The method does not use a report generator 58 to generate findings/evidence. Errors in the third column, versus the ground truth answer of the second column, are emphasised in bold. The fourth column titled ‘Evidence (generated report)’ refers to the evidence/findings generated in the report 60 at the output of the report generator 58. Parts of the generated report that are relevant to the ‘ground truth answer’ of column two are emphasised in bold in column 4. The fifth and final column titled ‘Predicted answer using evidence’ refers to the answer 64 provided by the answer generator 62 of method 50.

It can be seen that provision of the report 60 comprising findings/evidence improves the accuracy of the predicted answer 64 of the fifth column.

| | | Predicted | | |
|---|---|---|---|---|
| | | Answer | | |
| | | without | Evidence | Predicted |
| | Ground Truth | using | (Generated | Answer using |
| Question | Answer | Evidence | report) | Evidence |
| What has | The main | The main | FINDING: Left | The main |
| changed | image has | image has | subclavian | image has |
| compared | additional | additional | central venous | additional |
| to the | findings | findings | catheter tip | findings |
| reference | of pneumonia, | of lung | terminates in the | of pneumonia, |
| image? | edema, and lung | opacity, | mid svc. The | edema, |
| | opacity than | and pneumonia | heart size is | and lung |
| | the reference | than the | normal. | opacity than |
| | image. The | reference | mediastinal | the reference |
| | main image is | image. The | contours | image. The |
| | missing the | main image is | are unremarkable. | main image is |
| | finding | missing the | There is mild | missing the |
| | of cardiomegaly | finding | pulmonary | finding |
| | than the | of atelectasis | edema, new | of cardiomegaly |
| | reference | than the | from the prior | than the |
| | image. | reference | study. Patchy | reference |
| | | image. | bibasilar | image. |
| | | | airspace | |
| | | | opacities could | |
| | | | reflect | |
| | | | atelectasis but | |
| | | | infection or | |
| | | | aspiration is not | |
| | | | excluded. No | |
| | | | large pleural | |
| | | | effusion or | |
| | | | pneumothorax | |
| | | | is seen. | |
| | | | IMPRESSION: | |
| | | | Bibasilar | |
| | | | airspace | |
| | | | opacities could | |
| | | | reflect | |
| | | | aspiration or | |
| | | | infection. Small | |
| | | | bilateral pleural | |
| | | | effusions. | |
| Where in | Bibasilar area | Bilateral area | FINDING: Left | Bibasilar area |
| the image | | | subclavian | |
| is the lung | | | central venous | |
| opacity | | | catheter tip | |
| located? | | | terminates in the | |
| | | | mid svc. The | |
| | | | heart size is | |
| | | | normal. | |
| | | | Mediastinal | |
| | | | contours are | |
| | | | unremarkable. | |
| | | | There is mild | |
| | | | pulmonary | |
| | | | edema, new from | |
| | | | the prior | |
| | | | study. Patchy | |
| | | | bibasilar airspace | |
| | | | opacities could | |
| | | | reflect | |
| | | | atelectasis but | |
| | | | infection or | |
| | | | aspiration is not | |
| | | | excluded. No | |
| | | | large pleural | |
| | | | effusion or | |
| | | | pneumothorax is | |
| | | | seen. | |
| | | | IMPRESSION: | |
| | | | Bibasilar | |
| | | | airspace | |
| | | | opacities could | |
| | | | reflect aspiration | |
| | | | or infection. | |
| | | | Small bilateral | |
| | | | pleural effusions. | |
| What | Atelectasis | Atelectasis, | FINDING: As | Atelectasis |
| abnormalities | | pleural | compared to the | |
| are seen in | | effusion | previous | |
| this image? | | | radiograph, there | |
| | | | is no relevant | |
| | | | change. | |
| | | | elevation of the | |
| | | | right | |
| | | | hemidiaphragm | |
| | | | with subsequent | |
| | | | areas of | |
| | | | atelectasis | |
| | | | at the right | |
| | | | lung bases. | |
| | | | Borderline size | |
| | | | of the cardiac | |
| | | | silhouette | |
| | | | without pulmonary | |
| | | | edema. No | |
| | | | pleural | |
| | | | effusions. No | |
| | | | pneumonia. | |
| | | | IMPRESSION: | |
| | | | Stable | |
| | | | radiographic | |
| | | | appearance of | |
| | | | the chest. | |
| What level | Moderate | Severe | FINDING: As | Moderate |
| is the | | | compared to the | |
| cardiomegaly? | | | previous | |
| | | | radiograph, there | |
| | | | is no relevant | |
| | | | change. | |
| | | | Moderate | |
| | | | cardiomegaly | |
| | | | without pulmonary | |
| | | | edema. No | |
| | | | pleural effusions. | |
| | | | No pneumonia. | |
| | | | No pneumothorax. | |
| | | | IMPRESSION: | |
| | | | No acute | |
| | | | cardiopulmonary | |
| | | | radiographic | |
| | | | abnormality. | |
| What type | Patchy | Interstitial | FINDING: Mild | Patchy |
| is the lung | | | to moderate | |
| opacity? | | | cardiomegaly is | |
| | | | redemonstrated. | |
| | | | The aorta is | |
| | | | diffusely | |
| | | | calcified. There | |
| | | | is mild | |
| | | | pulmonary | |
| | | | edema with small | |
| | | | bilateral pleural | |
| | | | effusions. Patchy | |
| | | | opacities in | |
| | | | the lung | |
| | | | bases likely | |
| | | | reflect | |
| | | | atelectasis. No | |
| | | | pneumothorax is | |
| | | | present. There | |
| | | | are no acute | |
| | | | osseous | |
| | | | abnormalities. | |
| | | | IMPRESSION: | |
| | | | Mild pulmonary | |
| | | | edema with small | |
| | | | bilateral pleural | |
| | | | effusions. | |

According to various embodiments there is provided a medical information processing apparatus comprising processing circuitry configured to:
input medical image data to a first generative model that is configured to generate one or more findings based on the medical image; and
input the medical image data, question information, and the generated one or more findings to a second generative model that is configured to output answer information related to the medical image data.

The one or more findings may comprise clinical findings and/or evidence related to the medical image data and/or one or more reports. The question information may comprise a question in text form. The question information may be composed in natural language.

The second generative model may comprise an answer generator model. The second generative model may comprise an LLM. The second generative model may be configured to generate output answer information related to the medical image. The output answer information may comprise text data which may be in natural language and which may respond semantically to the question information.

The generated one or more findings may comprise at least one of:
(a) at least part of a radiology report, wherein the radiology report may be generated by a generative model;
(b) position information representing position of one or more landmarks, or one or more anatomical or other features of interest, wherein the position information may be in the form of one or more coordinates;
(c) segmentations of one or more anatomical or other features of interest which may define an area or volume of the features;
(d) measurements of one or more anatomical or other features of interest which may define dimensions or other quantitative measures of the features;
(e) one or more selected parts of the medical image data, which may be selected on the basis of clinical relevance; or
(f) one or more enhanced images or derived images obtained based on the medical image data, such as rendered images.

The generated one or more findings may comprise at least one of:
(a) text data, which may comprise natural language;
(b) co-ordinates, such as two or three dimensional spatial coordinates;
(c) at least one segmentation mask;
(d) at least one image.

The medical information processing apparatus may comprise a display system. The display system may be configured to display the answer information and at least part of a medical image together. The answer information may comprise text in natural language. The medical image may comprise at least part of the medical image data provided to the first and/or second generative model. The display system may be suitable for displaying the text comprising the answer information and at least part of the medical image data to a user.

The processing circuitry may be configured to select at least part of the medical image data based on the answer information. The display system or device may further display the selected at least part of the medical image data to a user.

The processing circuitry may be configured to select one or more display parameters based on the answer information and to display at least part of the medical image data in accordance with one or more display parameters. The display parameters may comprise rendering parameters applied to the medical image data. The display of at least part of the medical image data may comprise the at least part of the medical image data rendered in accordance with the selected one or more rendering parameters.

The processing circuitry and/or the first generative model may use a predetermined format for the output of the first generative model. The predetermined format may be applied to the generated one or more reports. The predetermined format may present the output of the first generative model in a structured and/or consistent format.

The processing circuitry and/or the second generative model may include or exclude information, for example received at its input, based on the expected accuracy of the information. The processing circuitry and/or the second generative model may further include or exclude a type of information based on its type.

The processing circuitry may be configured to vary the medical image data provided to the first generative model and/or second generative model in order to obtain a plurality of findings. The processing circuitry may alternatively or additionally vary other inputs to the first generative model to obtain a plurality of findings. The processing circuitry may also use a plurality of different or differently-trained first generative models in order to obtain a plurality of reports. The plurality of findings may comprise a plurality of different reports.

The plurality of findings, for example the plurality of reports, may comprise an ensemble of multiple predictions for a given item.

The plurality of findings, for example the plurality of reports, may have at least some different information content.

The processing circuitry, for example using a trained model, may generate a plurality of possible questions and corresponding answers from the generated reports. The processing circuitry, for example using a trained model, may be configured to select one or more of the possible questions based on how well they match the question information, and to output the answers that correspond to the selected one or more questions.

The medical image data may comprise a multi-modal data set that includes semantic and/or other additional information, and the inputting of the medical image data to the first generative model may comprise inputting the multi-modal data set to the first generative model.

At least one of the first generative model and second generative model may comprise at least one of a bidirectional encoder representations from transformers (GPT) model or other transformer network, or a large language model (LLM).

The inputting of the medical image data to the first generative model may comprise inputting a vector representation of the medical image data to the first generative model.

The inputting of the medical image data, question information and the generated one or more reports to the second generative model may comprise inputting at least one of the medical image, question information, and the generated one or more reports as a vector representation.

In various embodiments there is provided a medical imaging diagnostic apparatus comprising:
a scanner configured to scan a patient to obtain a medical image data set; and
processing circuitry configured to:
   input the medical image data to a first generative model that is configured to generate one or more findings based on the medical image; and
   input the medical image data, question information, and the generated one or more findings to a second generative model that is configured to output answer information related to the medical image data.

The processing circuitry may configured to obtain at least one stored previously-obtained medical image data set and input the previously-obtained medical image data set to the first generative model and/or to the second generative model for comparison between the medical image data set and the previously-obtained medical image data set.

In various embodiments there is provided a medical information processing method comprising:
inputting medical image data to a first generative model that is configured to generate one or more findings based on the medical image; and
inputting the medical image data, question information, and the generated one or more findings to a second generative model that is configured to output answer information related to the medical image data.

In various embodiments there is provided a computer program product comprising a computer readable medium storing instructions that are executable to perform a method comprising:
inputting medical image data to a first generative model that is configured to generate one or more findings based on the medical image; and
inputting the medical image data, question information, and the generated one or more findings to a second generative model that is configured to output answer information related to the medical image data.

In various embodiments there is provided a method for chain of evidence in medical VQA systems, comprising: a) a set of medical images annotated with relevant questions and corresponding answers; b) a set of radiology reports or other data corresponding to the medical images, which might be inferred from the image by a deep learning model; c) an evidence generator model that takes a target image as input; d) an answer generator model that takes as inputs the target image, a text question, and the generated evidence—and outputs a predicted answer for the question.

The evidence generator model c) may comprise a transformer network, for instance a GPT model. The answer generator model d) may comprise a transformer network, for instance a GPT model. The evidence generated by c) may comprise a radiology report. The evidence may be further processed into a consistent format. The evidence may be further processed to retain information known to be reliably reported and to remove information known to be unreliably reported. One or more of the models may be an LLM.

An ensemble of multiple predictions may be generated for a given evidence item, and the ensemble may be passed to the answer generator model. Potential question-answer pairs may be generated from the generated report, and similarity matching may be used to match user questions to the closest generated question.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms and modifications as would fall within the scope of the invention.

1. A medical information processing apparatus comprising processing circuitry configured to:
input medical image data generated by a medical imaging apparatus to a first generative model that is configured to generate one or more findings based on the medical image;
input the medical image data, question information, and the generated one or more findings to a second generative model that is configured to output answer information related to the medical image data; and
display, on a display device, the answer information and at least part of the medical image generated by the medical imaging apparatus.

2. The apparatus of claim 1, wherein the generated one or more findings comprise at least one of:
at least part of a radiology report;
position information representing position of one or more landmarks, or one or more anatomical or other features of interest;
segmentations of one or more anatomical or other features of interest;
measurements of one or more anatomical or other features of interest;
one or more selected parts of the medical image; or
one or more enhanced images or derived images obtained based on the medical image.

3. The apparatus of claim 1, wherein the generated one or more findings comprise at least one of text, co-ordinates, at least one segmentation mask, or at least one image.

4. The apparatus of claim 1, wherein the apparatus comprises a display system configured to display the answer information and at least part of the medical image on the same screen.

5. The apparatus of claim 4, wherein the processing circuitry is configured to select part of the medical image based on the answer information, and to display the selected part of the medical image based on the answer information.

6. The apparatus of claim 4, wherein the processing circuitry is configured to select one or more display parameters based on the answer information, and to display at least part of the medical image in accordance with the selected one or more display parameters.

7. The apparatus of claim 1, wherein the processing circuitry or the second generative model is configured to use a predetermined format for the generated one or more findings.

8. The apparatus of claim 1, wherein the processing circuitry or the second generative model is configured to include or exclude information of type of information from the at least one finding based on expected accuracy of the information or type of information.

9. The apparatus of claim 1, wherein the processing circuitry is configured to vary the medical image data and/or to vary other inputs to the first generative model and/or to use a plurality of different or differently-trained first models thereby to obtain a plurality of findings.

10. The apparatus of claim 9, wherein the plurality of findings comprises an ensemble of multiple predictions for a given item.

11. The apparatus of claim 9, wherein the plurality of findings have at least some different information content.

12. The apparatus of claim 1, wherein the processing circuitry is configured to generate a plurality of possible questions and corresponding answers from the generated findings.

13. The apparatus of claim 12, wherein the processing circuitry is configured to select one or more of the possible questions based on how well they match the question information, and to output the answers that correspond to the selected one or more questions.

14. The apparatus of claim 1, wherein the medical image data comprises a multi-modal data set that includes semantic or other additional information, and the inputting of the medical image to the first generative model comprises inputting the multi-modal data set to the first generative model.

15. The apparatus of claim 1, wherein one or both of the first generative model or second generative model comprises at least one of:
a GPT model or other transformer network; or
a large language model (LLM).

16. The apparatus of claim 1, wherein inputting of the medical image to the first generative model comprises inputting a vector representation of the medical image data to the first generative model; and/or
wherein inputting the medical image data, question information, and the generated one or more findings to the second generative model comprises inputting at least one of the medical image, question information, and the generated one or more findings as a vector representation.

17. A medical imaging diagnostic apparatus comprising:
a scanner configured to scan a patient to obtain a medical image data set; and
processing circuitry configured to:
input the medical image data to a first generative model that is configured to generate one or more findings based on the medical image; and
input the medical image data, question information, and the generated one or more findings to a second generative model that is configured to output answer information related to the medical image data.

18. A medical imaging diagnostic apparatus according to claim 17, wherein the processing circuitry is configured to obtain at least one stored previously-obtained medical image data set and input the previously-obtained medical image data set to the first generative model and/or to the second generative model for comparison between the medical image data set and the previously-obtained medical image data set.

19. A medical information processing method comprising:
inputting medical image data generated by a medical imaging apparatus to a first generative model that is configured to generate one or more findings based on the medical image;
inputting the medical image data, question information, and the generated one or more findings to a second generative model that is configured to output answer information related to the medical image data; and
displaying, on a display device, the answer information and at least part of the medical image generated by the medical imaging apparatus.

20. A computer program product comprising a computer readable medium storing instructions that are executable to perform a method comprising:
inputting medical image data generated by a medical imaging apparatus to a first generative model that is configured to generate one or more findings based on the medical image;
inputting the medical image data, question information, and the generated one or more findings to a second generative model that is configured to output answer information related to the medical image data; and
displaying, on a display device, the answer information and at least part of the medical image generated by the medical imaging apparatus.
